(19) United States
(12) Patent Application Publication
(10) Pub. No.: US 2016/0048457 A1
(43) Pub. Date: Feb. 18, 2016

(54) DYNAMIC MEMORY ADDRESS REMAPPING IN COMPUTING SYSTEMS

(71) Applicant: THE BOEING COMPANY, Chicago, IL (US)

(72) Inventor: Laszlo Hars, Lafayette, CO (US)

(73) Assignee: THE BOEING COMPANY, Chicago, IL (US)

(21) Appl. No.: 14/459,234

(22) Filed: Aug. 13, 2014

(51) Int. Cl. G06F 12/14; G06F 12/02

(52) U.S. Cl. CPC G06F 12/14; G06F 12/0292; G06F 2212/1052; G06F 2212/152; G06F 2212/65

(57) ABSTRACT

A method provides security in a computing system including a processor having a logical address space and external system memory having physical address space. The method comprises hiding memory access patterns, including dynamically remapping the logical address space to the physical address space in response to data accesses to the logical address space.

### BACKGROUND

In a computing system, traffic to system memory may be analyzed to observe memory access patterns. Sensitive information from these memory access patterns may be deduced.

Location of an event counter may be deduced from writing new data to an address in response to an event. Neighboring fields may have known values (e.g. leading zeros). This deduced information may be used for a cryptanalytic attack such as a key search attack or a power analysis attack.

Frequent, periodic updates might point to a loop counter. Sequential memory access, with occasional jumps and loops, may indicate program code. Certain access patterns may reveal matrix computations, image processing, database handling, etc. This deduced information can give the location of important targets for attacks.

Memory access patterns may also be analyzed to identify an executed algorithm in software, functionality of the software, or just a version of the software. This deduced information may enable known flaws in the software to be exploited.

### SUMMARY

According to an embodiment herein, a method provides security in a computing system including a processor having a logical address space and external system memory having physical address space. The method comprises hiding memory access patterns, including dynamically remapping the logical address space to the physical address space in response to data accesses to the logical address space.

According to another embodiment herein, a computing system comprises a processor having logical address space, external system memory having physical address space, and a memory controller for hiding memory access patterns with respect to the external system memory. Hiding the memory access patterns includes dynamically remapping the logical address space to the physical address space in response to data accesses to the logical address space.

According to another embodiment herein, a memory controller for a computing system comprises a dedicated processor configured to hide memory access patterns with respect to external system memory of a computing system. Hiding the memory access patterns includes remapping a logical address from a first physical address of the external system memory to a second physical address of the external system memory in response to a data access to the logical address space; and sending data to the external system memory for storage at the second physical address.

These features and functions may be achieved independently in various embodiments or may be combined in other embodiments. Further details of the embodiments can be seen with reference to the following description and drawings.

### BRIEF DESCRIPTION OF THE DRAWINGS

FIG. 1 is an illustration of a computing system that thwarts analysis of traffic to external system memory.

FIG. 2A is an illustration of a method of obfuscating a write operation to a logical address.

FIG. 2B is an illustration of a method of obfuscating a read operation to a logical address.

FIG. 2C is an illustration of another method of obfuscating a write operation to a logical address.

FIG. 3 is an illustration of data structures for remapping logical address space to physical address space.

FIG. 4 is an illustration of a method of using the data structures of FIG. 3 to perform the remapping.

FIGS. 5, 6 and 7 are illustrations of different examples of computing systems that thwart analysis of traffic to external system memory.

### DETAILED DESCRIPTION

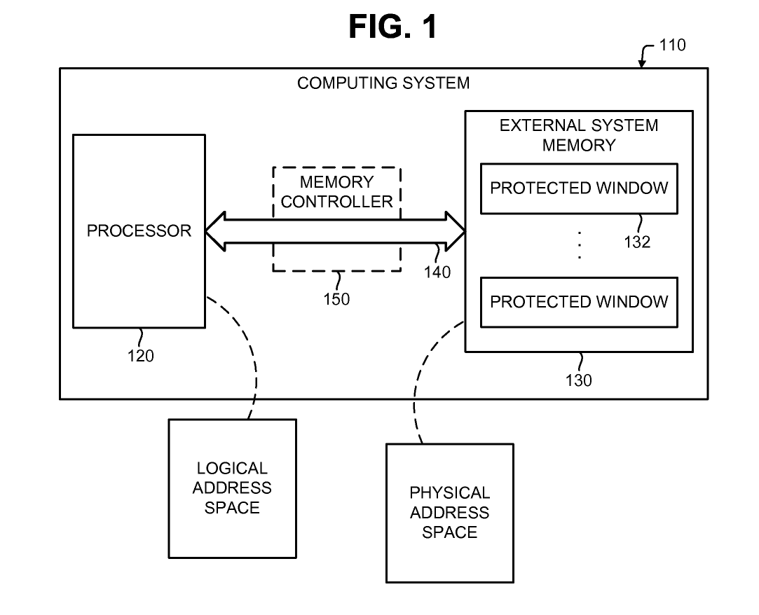

Reference is made to FIG. 1, which illustrates a computing system 110 including a processor 120. Examples of the processor 120 include, but are not limited to, a central processing unit, a Direct Memory Access (“DMA”) engine or other embedded processor, and an application-specific integrated circuit (“ASIC”).

The computing system further includes external system memory 130, which communicates with the processor 120 via a data path 140. As used herein, “system memory” refers to memory where the computing system 110 holds current programs and data that are in use. Examples of system memory include volatile system memory such as dynamic random access memory (“DRAM”) and non-volatile system memory such as magnetic random access memory (“MRAM”). The system memory does not include storage devices such as hard drives and Flash memory.

The system memory is considered “external” if traffic on the data path 140 can be accessed and observed by an attacker. As used herein, “traffic” refers to the communication information between the processor 120 and the external system memory 130. This communication information includes but is not limited to read/write signals, memory addresses, timing information, and data that is read from and written to the external system memory 130. The system memory may also include processor cache and registers. However, the processor cache and registers are not considered external if they cannot be accessed by an attacker.

The external system memory 130 stores data in protected windows 132. The data stored in the protected windows 132 is protected against traffic analysis. As used herein, a “protected window” refers to a single memory address or a range of contiguous addresses in the external system memory 130. In some instances, the protected data may be stored in a single protected window 132, which may cover a portion of the external system memory 130 or all of the external system memory 130. In other instances, the protected data may be stored in multiple protected windows 132, which may cover a portion of the external system memory 130 or all of the external system memory 130. The data stored in each protected window 132 may or may not be protected by other means (e.g., encryption and/or data authentication tags).

Physical address space is a set of ranges of physical addresses that the external system memory 130 utilizes for referencing data locations. The physical address space may also include addresses for memory other than the external system memory 130.

Logical address space is a set of ranges of logical addresses that the processor 120 utilizes for referencing data locations. For instance, a computer program works only with logical addresses.

The computing system 110 further includes a memory controller 150, which manages the flow of data to and from the external system memory 130. As part of managing the data flow, the memory controller 150 is configured to map and dynamically remap the logical address space to the physical address space of the external system memory 130. The memory controller 150 also translates logical addresses to physical addresses. That is, the memory controller 150 receives logical addresses from the processor 120, and sends corresponding (mapped) physical addresses to the external memory 130.

In FIG. 1, the memory controller 150 is shown in dashed lines to convey that it may be implemented in either the processing side of the computing system 110 or the memory side of the computing system 110. As examples of processing side implementation, the memory controller 150 may be located on a die of the processor 120, or it may be part of an operating system. As examples of memory side implementation, the memory controller 150 may be located on a substrate of the external system memory 130, or on a motherboard or other printed circuit board. Preferably, the memory controller 150 is integrated with the processor 120 (e.g., on the same die, as a protected multi-chip module, in firmware) where it is not accessible to an attacker. If the memory controller 150 is not integrated with the processor 120, communication lines with the processor 120 are protected against access by an attacker.

Observation and analysis of traffic on the data path 140 can reveal memory access patterns. This, in turn, might allow an attacker to gain insights about the data in the protected windows 132 and about actions of the processor 120.

The memory controller 150 is configured to thwart such traffic analysis by obfuscating the memory access patterns. The obfuscation includes dynamically remapping the logical address space of the processor 120 to the physical address space of the external system memory 130. The remapping is performed at data accesses to the logical address space. For instance, a remapping may be performed at a read or write to a logical address.

The obfuscation further includes storing data in the external system memory 130 after a remapping. For instance, after a logical address is remapped from a first physical address to a second physical address, data is stored at the second physical address.

For maximum protection against traffic analysis, the remapping may be performed at each and every data access to the logical address space. However, the remapping may be performed less frequently. In any event, the remapping is dynamic. For instance, the remapping is performed repeatedly while a program is running.

The remapping may not involve remapping the entire logical address space (that is, every logical address). Rather, the remapping may involve only the logical addresses that are designated for protection, and perhaps an additional subset of the logical address space.

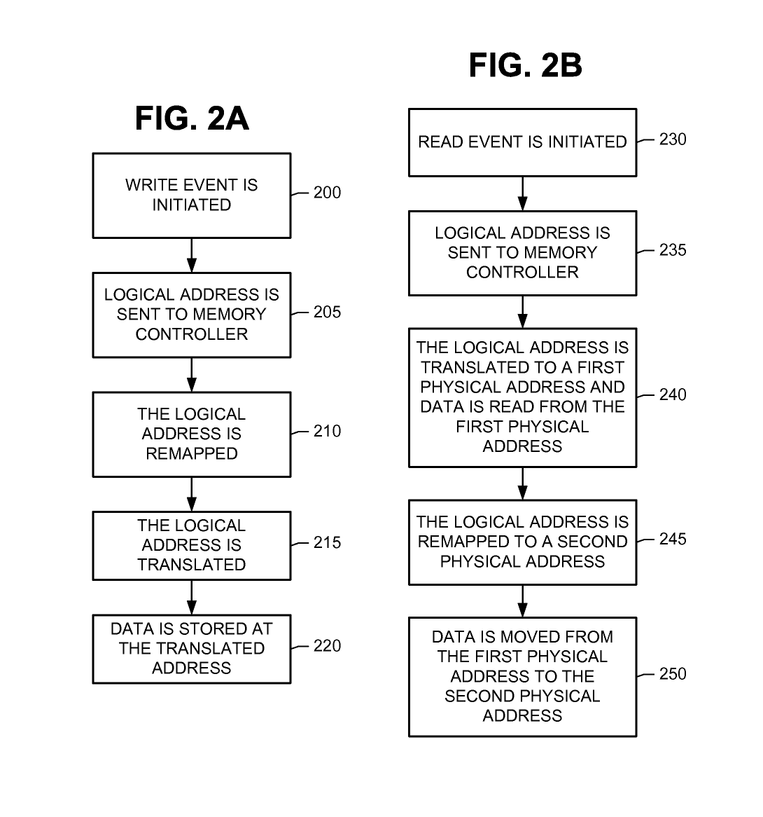

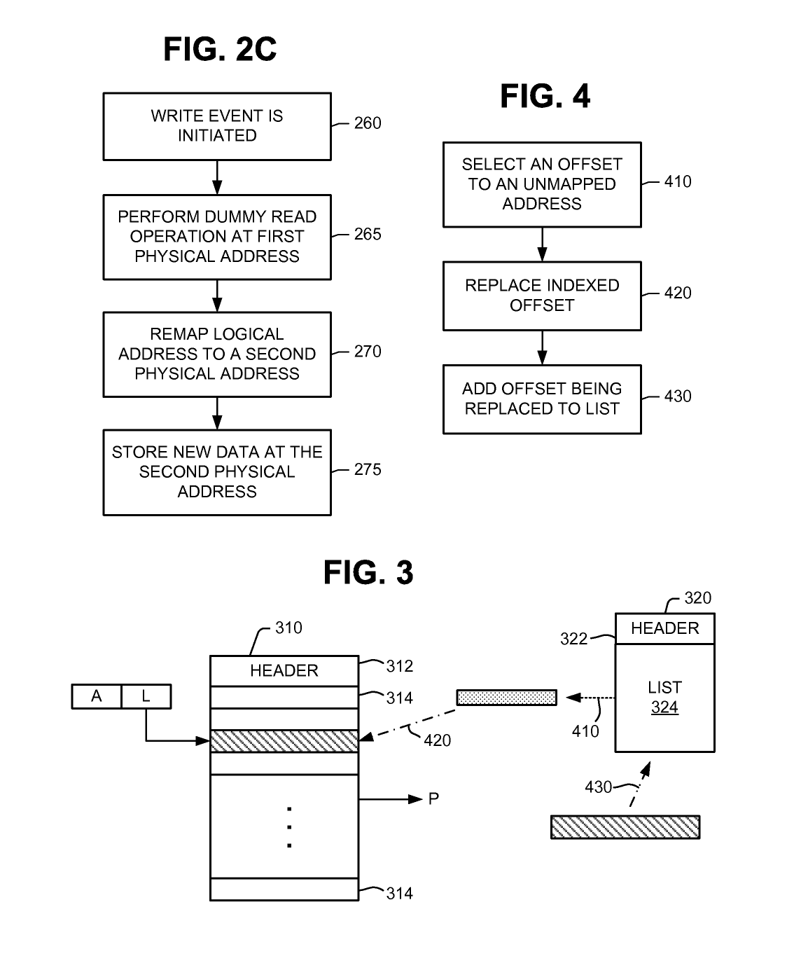

FIG. 2A illustrates an example of obfuscating a write operation to a logical address. At block 200, a write event is initiated. The write event may be initiated by the processor 120, a DMA engine, I/O or other active component of the computing system 110.

At block 205, a logical address, write flag and data are sent to the memory controller 150 as part of a write command. At this point in time, the logical address is mapped to a first physical address in the external system memory 130.

At block 210, the logical address is remapped. An unmapped second physical address is identified, and the logical address is remapped to that second physical address.

At block 215, the memory controller 150 translates the logical address to the second physical address. At block 220, the data is stored at the second physical address in the external system memory 130, yet the logical address is unchanged

FIG. 2B illustrates an example of obfuscating a read operation to a logical address. At block 230, a read event is initiated. At block 235, a logical address and read flag are sent to the memory controller 150. At block 240, the memory controller 150 translates the logical address to a first physical address, and the external system memory 130 sends data at that first physical address to the memory controller 150.

At block 245, the logical address is remapped. An unmapped second physical address is identified, and the logical address is remapped to that second physical address.

At block 250, the data is moved from the first physical address to the second physical address. Thus, after data is read from the external system memory 130, the data is moved to a new location in the external system memory 130, yet the logical address is unchanged.

In some configurations, the operations at blocks 245 and 250 may be performed automatically by the memory controller 150 after executing a read command issued by the processor 120. In other configurations, the processor 120 issues a read command followed by a write command, whereby the read command causes the memory controller 150 to perform the functions at blocks 235 and 240, and the write command causes the memory controller 150 to perform the functions at blocks 245 and 250.

FIG. 2C illustrates another method of obfuscating a write operation. A write operation may be further obfuscated by automatically preceding it by one or more dummy read operations. At block 260, a write event is initiated. At block 265, a dummy read operation is performed. A logical address and a dummy read flag are sent to the memory controller 150, which translates the logical address to a first physical address, and retrieves data at that first physical address from the external system memory 130. Since the operation is a dummy read operation, the data is not acted upon, except that the memory controller 150 may check integrity and authenticity of the retrieved data.

The dummy read operation is followed by the write operation. At block 270, the logical address is remapped to a second physical address. At block 275, new data is written to the second physical address. If additional dummy read operations are performed, each dummy read operation (block 265) may be followed by a remapping (block 270) and writing of new data (block 275).

In these obfuscations, the physical addresses change, but the logical addresses do not change. Writing to the same logical address will cause data to be written to different physical addresses in the external system memory 130. In this manner, the memory address remapping is used to obfuscate memory access patterns.

Reference is now made to FIGS. 3 and 4. FIG. 3 illustrates an example of data structures for the mapping and remapping of logical address space to physical address space, and FIG. 4 illustrates an example of how the memory address remapping may be performed. The data structures in this example include first and second tables 310 and 320. A first table 310 and a second table 320 are provided for each protected window 132 in the external system memory 130. Each protected window 132 stores data. The smallest addressable unit of data may be a byte (8 bits), a memory page (e.g. 64 bytes), a ciphertext block (16 bytes), etc. These smallest addressable units will be referred to as “chunks.”

Each first table 310 may include a header 312, which contains the starting logical address of its protected window 132. Each first table 310 may further includes as many entries 314 as there are chunks in the protected window 132.

The entries 314 are indexed by the logical address (e.g., the entire logic address or a portion of the logical address). For instance, a logical address has a base A and offset L. The first table 310 may be indexed by the offset L. The offset L points to an entry 314 whose value P enables a physical address to be determined. In some configurations, the values of the entries 314 may represent offsets of the physical addresses from the beginning of the protected window 132. In other configurations, the values of the entries 314 may represent absolute physical addresses, offsets from the beginning of a memory page, etc.

The second table 320 includes a header 322 and a list 324 of entry values for unmapped physical addresses. Each entry value enables its corresponding physical address to be determined. The physical address space is larger than the logical address space by at least one physical memory location. Therefore, at least one physical address will always be unmapped.

A remapping operation utilizes this second table 320. Consider an example in which the first and second tables 310 and 320 store values of offsets. At the start of a remapping operation, the offset L of the logical address points to an offset in the first table 310. The offset being indexed (represented by the box having a cross-hatched fill pattern) is referred to as the “first” offset.

At block 410, an offset to an unmapped physical address is selected from the list 324 in the second table 320 (this action is represented by the dash line in FIG. 3). The selected offset (represented by the box having a speckled fill pattern) is referred to as the “second” offset. The second offset may be selected randomly or pseudorandomly from the list 324.

At block 420, the first offset in the first table 310 is replaced with the second offset (this action is represented by the dot-dash line in FIG. 3). That is, the offset indexed by the logical address is replaced with the offset selected from the second table 320.

At block 430, the first offset is now added to the list 324 of offsets to unmapped addresses. This action is represented by the dot-dot-dash line in FIG. 3.

The remapping happens at the level of memory accesses. At this low level, there is no concept of programs.

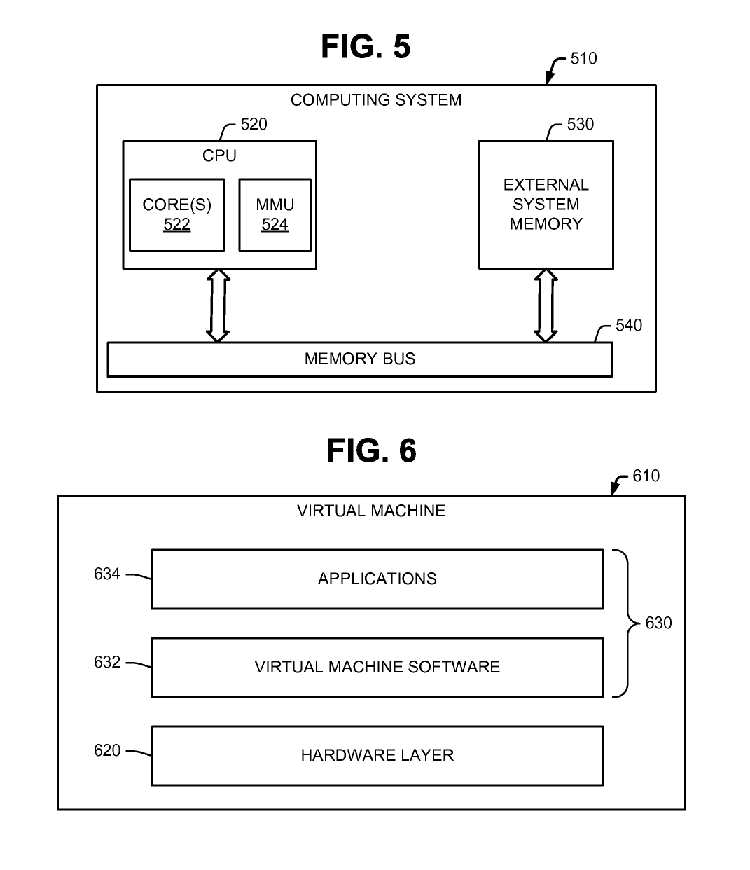

As mentioned above, the memory controller 150 may be implemented in the computing system 110 in various ways. FIGS. 5, 6 and 7 provide three examples.

FIG. 5 illustrates a computing system 510 including a central processing unit (CPU) 520 that communicates with external system memory 530 via a memory bus 540. The CPU 520 includes one or more cores 522 and a memory management unit (MMU) 524. The memory management unit 524 receives a logical address from the core(s) 522, and translates the logical address to a physical address, which is placed on the memory bus 540. The memory management unit 524 also performs dynamic memory address remapping as described above. The memory management unit 524 may include cache, registers, or other private memory for implementing the tables, and logic for controlling the address translation. The memory address remapping is independent of any caching scheme.

FIG. 6 illustrates a virtual machine 610 including a hardware layer 620 and a software layer 630. The software layer 630 includes virtual machine software 632, and application software 634. The virtual machine software 632 runs on the hardware layer 620 to map and remap the logical addresses used by the application software 634 to virtual addresses. The virtual addresses may be mapped to physical addresses either by the combination of the virtual machine software 632 and the hardware layer 620, or by a memory management unit in the hardware layer 620.

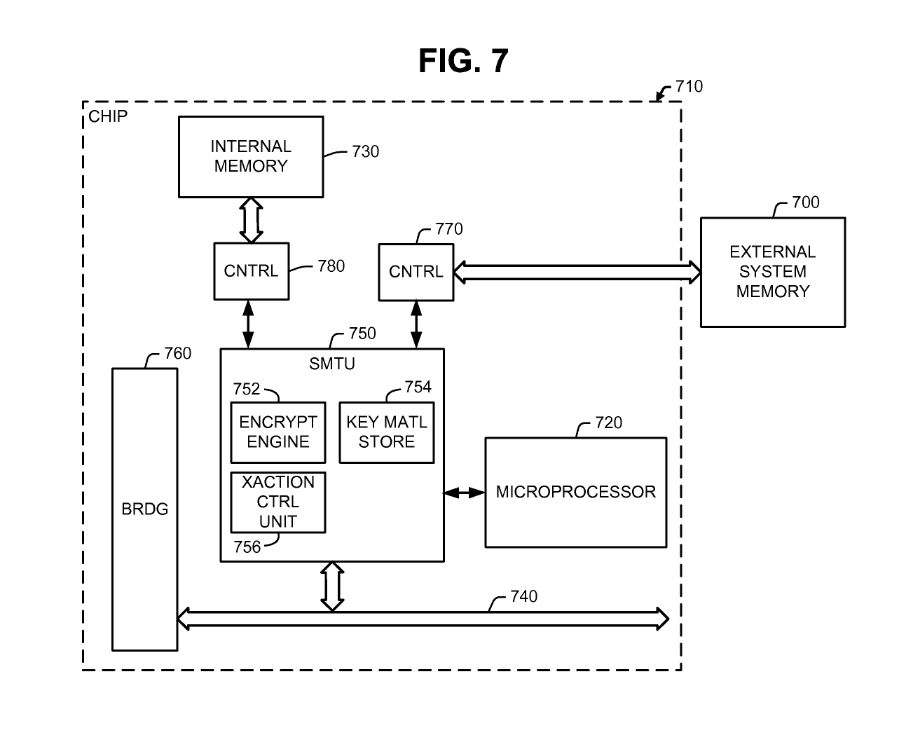

FIG. 7 illustrates a system-on-a-chip (SoC) architecture similar to the SoC architecture described in assignee's U.S. Publication No. 20130117577. The chip 710 communicates with off-chip external system memory 700. The chip 710 includes a microprocessor 720, volatile internal memory (e.g., EDRAM) 730, and a memory bus 740. Some configurations may follow a CoreConnect™ bus architecture for system-on-a-chip (SoC) designs, wherein the microprocessor 720 is a PowerPC core, and the memory bus 740 is a processor local bus (PLB).

The chip 710 also includes a dedicated circuit referred to as a secure memory transaction unit (“SMTU”) 750. The SMTU 750 communicates directly with the microprocessor 720, and it communicates with a bridge 760 via the memory bus 740. The SMTU 750 communicates with the external system memory 700 via a first memory controller 770, and it communicates with the internal memory 730 via a second memory controller 780.

The SMTU 750 provides an encryption and authentication engine 752 for encrypting and authenticating data stored in the external system memory 700. Dedicated memory referred to as a key material store 754 is used to store key material for the encryption and authentication. The SMTU 750 may act as a slave unit serving read and write requests initiated by the microprocessor 720 or by units coupled to the bridge 760.

The address translation and dynamic memory address remapping may be performed by the SMTU 750. For example, the SMTU 750 may include a transaction control unit 756 for identifying protected windows in the external system memory, and deciding how data stored in those windows are protected. The transaction control unit 756 may also perform the address translation and the dynamic memory address remapping. If the remapping utilizes data structures such as tables, the tables may be stored in the internal memory 730.

In other configurations, the address translation and dynamic memory address remapping may be performed by the first memory controller 770. In still other configurations, the microprocessor 720 may be programmed to perform the address translation and dynamic memory address remapping.

A computing system herein is not limited to any particular usage. Examples include flight computers, personal computers, work stations, laptop computers, and smart mobile devices.

1. A method of providing security in a computing system including a processor having a logical address space and external system memory having physical address space, the method comprising:
hiding memory access patterns including dynamically remapping the logical address space to the physical address space in response to data accesses to the logical address space.

2. The method of claim 1, wherein the external system memory holds current programs and data that are in use, and communicates with the processor over a data path that is accessible to an attacker.

3. The method of claim 1, wherein the remapping is performed at each and every data access to the logical address space.

4. The method of claim 1, wherein each remapping includes remapping a logical address from first a physical address to a second physical address; and wherein hiding the memory access patterns further includes storing data at the second physical address.

5. The method of claim 1, wherein for each read operation at a logical address, data is read from a first physical address in the external system memory, the logical address is remapped from the first physical address to a second physical address, and the data is moved from the first physical address to the second physical address, yet the logical address is unchanged.

6. The method of claim 1, wherein for each write operation to a logical address, the logical address is remapped from a first physical address to a second physical address, and data is stored at the second physical address, yet the logical address is unchanged.

7. The method of claim 6, wherein each write operation is preceded by a dummy read operation, in which data is read from the first physical address but is not acted upon.

8. The method of claim 1, wherein the physical address space is larger than the logical address space by at least one physical address, whereby at least one physical address is unmapped; wherein a first data structure contains entry values for those physical addresses mapped to logical addresses; wherein a second data structure contains an entry value for each unmapped physical address; and wherein an entry value indexed in the first data structure is replaced by an entry value selected from the second data structure.

9. The method of claim 8, wherein each replaced entry value is added to the second data structure.

10. The method of claim 8, wherein each entry value in the second data structure is selected randomly or pseudorandomly.

11. The method of claim 8, wherein each entry value is an offset from a corresponding beginning address of a protected window of the external system memory.

12. A computing system comprising:
a processor having logical address space;
external system memory having physical address space; and
a memory controller for hiding memory access patterns with respect to the external system memory, wherein hiding the memory access patterns includes dynamically remapping the logical address space to the physical address space in response to data accesses to the logical address space.

13. The computing system of claim 12, wherein the processor and the memory controller are on a die of a central processing unit.

14. The computing system of claim 12, wherein the computing system is a virtual machine having a hardware layer and virtual machine software that implement the memory controller.

15. The computing system of claim 12, wherein the computing system is a system-on-a-chip including a circuit that communicates with the external system memory; and wherein the circuit is configured to dynamically perform the memory address remapping.

16. The computing system of claim 15, wherein the circuit is a Secure Memory Transaction Unit.

17. The computing system of claim 12, wherein the memory controller is configured to perform the remapping at each and every data access to a logical address.

18. The computing system of claim 12, wherein the memory controller is configured to remap a logical address from first a physical address to a second physical address, and to store data at the second physical address.

19. The computing system of claim 12, wherein the physical address space is larger than the logical address space by at least one physical address, whereby at least one physical address is unmapped; wherein when a data access to a logical address is made, the logical address is already mapped to a first physical address via a first offset; and wherein the memory controller is configured to select a second offset to an unmapped second physical address, and replace the first offset with the second offset.

20. A memory controller for a computing system including external system memory, the memory controller comprising a dedicated processor configured to hide memory access patterns with respect to the external system memory, including remapping a logical address from a first physical address of the external system memory to a second physical address of the external system memory in response to a data access to the logical address space; and sending data to the external system memory for storage at the second physical address.
